(19) United States
(12) Patent Application Publication
(10) Pub. No.: US 2026/0172623 A1
(43) Pub. Date: Jun. 18, 2026

(54) VIDEO FRAME SYNCHRONIZATION BETWEEN DISPLAYS ASSOCIATED WITH SEPARATE DEVICES

(71) Applicant: QUALCOMM Incorporated, San Diego, CA (US)

(72) Inventors: Adi MENACHEM, Hod Hasharon (IL); Christian WIESNER, Uxbridge (CA); Aviad ZACKS-SHTRAUSS, Haifa (IL); Amit GIL, Zichron Yaakov (IL); Ziv HOROVITZ, Ram-On (IL)

(21) Appl. No.: 18/978,057

(22) Filed: Dec. 12, 2024

(51) Int. Cl. H04N 21/43; H04N 21/8547

(52) U.S. Cl. CPC H04N 21/43076; H04N 21/8547

(57) ABSTRACT

Various aspects of the present disclosure generally relate to data streaming. In some aspects, a first device may identify a timing associated with a third device that is communicatively coupled to the first device, wherein the timing is a reference timing that is maintained at the first device and at a second device that is communicatively coupled to the first device. The first device may perform a video frame synchronization between a first display associated with the first device and a second display associated with the second device, based at least in part on the timing associated with the third device. Numerous other aspects are described.

### FIELD OF THE DISCLOSURE

Aspects of the present disclosure generally relate to data streaming and, specifically, to techniques and apparatuses for video frame synchronization between displays associated with separate devices.

### BACKGROUND

Extended reality (XR) may encompass immersive technologies that combine a real world with a virtual world. XR may integrate various technologies, such as virtual reality (VR), augmented reality (AR), and mixed reality (MR), where each technology may offer different levels of interaction and immersion. VR may completely immerse a user in the virtual world. AR may overlay digital content onto the real world, which may allow a user to see both the real world and the virtual world simultaneously. MR may be a hybrid of AR and VR, where the real world and virtual elements may be blended such that the virtual elements may interact with and respond to the real world.

### SUMMARY

In some implementations, a first device includes one or more components configured to: identify a timing associated with a third device that is communicatively coupled to the first device, wherein the timing is a reference timing that is maintained at the first device and at a second device that is communicatively coupled to the first device; and perform a video frame synchronization between a first display associated with the first device and a second display associated with the second device, based at least in part on the timing associated with the third device.

In some implementations, a method includes identifying, at a first device, a timing associated with a third device that is communicatively coupled to the first device, wherein the timing is a reference timing that is maintained at the first device and at a second device that is communicatively coupled to the first device; and performing, at the first device, a video frame synchronization between a first display associated with the first device and a second display associated with the second device, based at least in part on the timing associated with the third device.

In some implementations, an apparatus comprises: means for identifying, at a first device, a timing associated with a third device that is communicatively coupled to the first device, wherein the timing is a reference timing that is maintained at the first device and at a second device that is communicatively coupled to the first device; and means for performing, at the first device, a video frame synchronization between a first display associated with the first device and a second display associated with the second device, based at least in part on the timing associated with the third device.

In some implementations, a first device includes one or more components configured to: identify a timing associated with a second device that is communicatively coupled to the first device, wherein the timing is a reference timing that is maintained at the first device; and perform a video frame synchronization between a first display associated with the first device and a second display associated with the second device, based at least in part on the timing associated with the second device.

In some implementations, a method includes identifying a timing associated with a second device that is communicatively coupled to the first device, wherein the timing is a reference timing that is maintained at the first device; and performing a video frame synchronization between a first display associated with the first device and a second display associated with the second device, based at least in part on the timing associated with the second device.

In some implementations, an apparatus comprises: means for identifying a timing associated with a second device that is communicatively coupled to the first device, wherein the timing is a reference timing that is maintained at the first device; and means for performing a video frame synchronization between a first display associated with the first device and a second display associated with the second device, based at least in part on the timing associated with the second device.

Aspects generally include a method, apparatus, system, computer program product, non-transitory computer-readable medium, memory device, or processing system as substantially described with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only some typical aspects of this disclosure and are therefore not to be considered limiting of its scope, for the description may admit to other equally effective aspects. The same reference numbers in different drawings may identify the same or similar elements.

FIG. 1 is a diagram illustrating an example associated with providing extended reality (XR) functionalities via multiple displays, in accordance with the present disclosure.

FIG. 2 is a diagram illustrating an example associated with a dual bus system architecture for providing XR functionalities via multiple displays, in accordance with the present disclosure.

FIG. 3 is a diagram illustrating an example associated with video frame synchronization between displays associated with separate devices, in accordance with the present disclosure.

FIG. 4 is a diagram illustrating an example associated with video frame synchronization between displays associated with separate devices, in accordance with the present disclosure.

FIG. 5 is a diagram illustrating an example associated with video frame synchronization between displays associated with separate devices, in accordance with the present disclosure.

FIG. 6 is a diagram illustrating an example associated with video frame synchronization between displays associated with separate devices, in accordance with the present disclosure.

FIG. 7 is a diagram of example components of one or more devices of FIGS. 3-4.

FIG. 8 is a flowchart of an example method associated with video frame synchronization between displays associated with separate devices.

FIG. 9 is a flowchart of an example method associated with video frame synchronization between displays associated with separate devices.

### DETAILED DESCRIPTION

A user equipment (UE) may support one or more extended reality (XR) functionalities. The one or more XR functionalities may include augmented reality (AR), virtual reality (VR), or mixed reality (MR), among other examples. For example, when providing an XR service, the UE may provide rendered data via multiple displays. For example, the UE may provide the rendered data to multiple displays associated with the UE. For example, the multiple displays may be associated with a set of XR goggles or a head-mounted display, which may be connected to and/or incorporated into the UE.

The one or more XR functionalities may be supported by an application server. The application server may host an application, such as a gaming application, a video streaming application, an XR, VR, or AR application, and/or another type of application for which flows of streaming data are provided between the UE and the application server. The UE may execute an application client associated with the application hosted by the application server, such as a gaming application client, a video streaming application client, an XR application client, a VR application client, an AR application client, and/or another type of application client.

The UE may provide the rendered data to the multiple displays in accordance with a universal serial bus (USB) standard, such as a universal serial bus 4 (USB4) standard. The USB4 standard may support various features, such as high-speed data transfers, video output, and/or charging over a single cable. The USB4 standard may support relatively high maximum data transfer rates, which makes the USB4 standard suitable for tasks that demand relatively high bandwidth, such as connecting multiple external displays, transferring large files, and/or using high-speed storage devices. The USB4 standard may support the handling of multiple 4K resolution displays, which may allow for the multiple external displays to be connected via a single USB port.

The UE may include a host, a hub, and a device. The host may be a USB4 host, the hub may be a USB4 hub, and the device may be a USB4 device, in accordance with a USB4 standard. The host may be a compute device. The hub may be associated with a first display. The device may be associated with a second display. The first display may display rendered data to a first eye of a user associated with the UE. The second display may display rendered data to a second eye of the user associated with the UE. The host may be associated with a data source, which may be used when providing rendered data to the first display and the second display. The rendered data may be associated with an XR use case.

The USB4 standard may support accurate time synchronization between the host, the hub, and the device, which may allow for a display clock frequency reconstruction. In the USB4 protocol, the display clock frequency reconstruction may be based on time synchronization packets that are indicated in a data stream from the host. The time synchronization packets may indicate timing information, which may be used for the display clock frequency reconstruction. The time synchronization packets may be embedded in the data stream because the hub and the device do not typically transmit a separate clock signal. The time synchronization packets may allow the hub and the device to perform the display clock frequency reconstruction. The display clock frequency reconstruction may be critical for data transmission, display outputs, and/or data integrity in USB4 applications. For example, the hub and the device may rely on display clock frequency reconstruction to maintain synchronized data transmission.

However, the USB4 standard may not provide a frame synchronization capability between multiple data streams. The USB4 standard may allow for accurate display clock frequency reconstruction, but may not support the frame synchronization capability between the multiple data streams. For example, the host may provide a first data stream and a second data stream. The first data stream may be displayed via the first display associated with the hub and the second data stream may be displayed via the second display associated with the device. The first data stream and the second data stream may be associated with the XR use case. The user may use the first eye to view the first data stream and the second eye to view the second data stream. Without the frame synchronization capability, the first data stream may not be frame synchronized with the second data stream, such that the user may view slightly different content on the first display associated with the hub versus the second display associated with the device. In other words, the content viewed by the first eye may not be synchronized with the content viewed by the second eye. The USB4 standard does not define a mechanism for synchronizing display specific events across two chips associated with two data streams, respectively. A lack of ability to synchronize the frames or presentation times of displayed content may result in a degraded user experience when the user is interacting with XR devices, especially in a low frame-rate context. The low frame-rate context may cause a non-synchronization between the first data stream and the second data stream to be more apparent to the user, thereby degrading the user experience.

Various aspects relate generally to video frame synchronization between displays associated with separate devices. In some aspects, a first device, such as a hub (e.g., a USB4 hub), may identify a timing associated with a third device, such as a host (e.g., a USB4 host). The third device may be communicatively coupled to the first device. The timing may be a reference timing that is maintained at the first device. The timing may also be maintained at a second device, such as a USB4 device. The second device may be communicatively coupled to the first device. The second device may be communicatively coupled to the third device via the first device. The first device may perform a video frame synchronization between a first display associated with the first device and a second display associated with the second device, based at least in part on the timing associated with the third device. The video frame synchronization may be between a first data stream and a second data stream, where the first data stream may be displayed via the first display and the second data stream may be displayed via the second display. The video frame synchronization may include a synchronization between specific display events in relation to the first display and the second display, where the specific display events may include a frame start event and/or a blank start event.

In some aspects, when performing the video frame synchronization, the first device may send, to the second device, a frame synchronization indication of the timing associated with the third device and/or a presentation timestamp, where the video frame synchronization may be based at least in part on the frame synchronization indication. In some aspects, the frame synchronization indication may be a non-USB4 indication. The non-USB4 indication (e.g., an out-of-band indication) may be sent between a general-purpose input/output (GPIO) entity (e.g., GPIO pin) associated with the first device and a GPIO entity associated with the second device. GPIO entities in devices may be out-of-band GPIO entities. In some aspects, the video frame synchronization may be based at least in part on a pre-configuration or any other non-USB4 in-band agreement that uses a USB4 host router reconstructed time and triggers synchronization events between two or more displays in a manner external to USB4 (but still uses a USB4 accurate clock reconstruction for phase synchronization). In some aspects, the frame synchronization indication may be a USB4 indication. The USB4 indication may be sent between a USB4 port associated with the first device and a USB4 port associated with the second device. The USB4 indication may be conveyed via a dedicated USB4 packet, or the USB4 indication may be embedded as a field in an USB4 packet.

In some aspects, the first device may be the USB4 hub, the second device may be the USB4 device, and the third device may be the USB4 host. Alternatively, the first device may be a first USB4 hub, the second device may be a second USB4 hub, and the third device may be the USB4 host In some aspects, the first device, the second device, and the third device may be associated with a UE, where the UE may be capable of supporting an XR functionality.

Particular aspects of the subject matter described in this disclosure can be implemented to realize one or more of the following potential advantages. In some examples, by enabling the video frame synchronization using the timing associated with the third device, the first device may perform the video frame synchronization between the first display associated with the first device and the second display associated with the second device. When a user is viewing the first display via a first eye and the second display via a second eye, the first display may be frame synchronized with the second display, thereby improving an overall system performance. The first device, the second device, and/or the third device may support an ability to synchronize frames and/or presentation times of displayed content, especially in low frame-rate contexts, which may improve the overall system performance.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented, or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

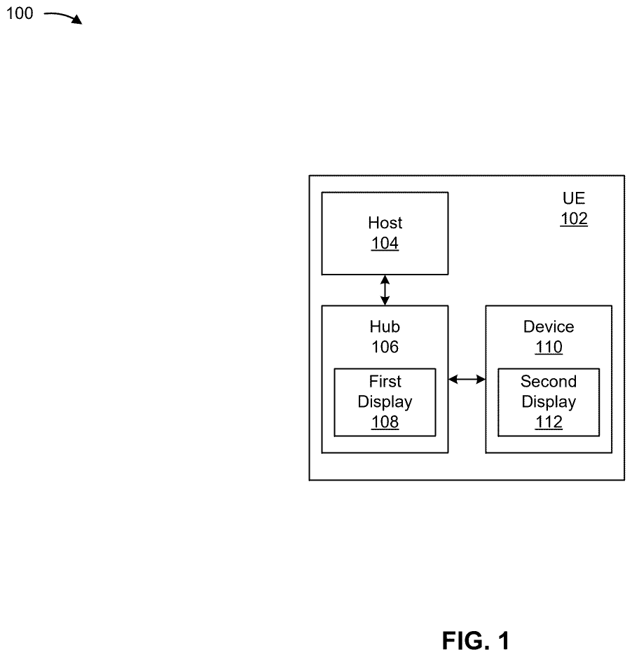

FIG. 1 is a diagram illustrating an example 100 associated with providing XR functionalities via multiple displays, in accordance with the present disclosure.

As shown in FIG. 1, a UE 102 may include a host 104, a hub 106, and a device 110. The host 104 may be a USB4 host, the hub 106 may be a USB4 hub, and the device 110 may be a USB4 device, in accordance with a USB4 standard. The host 104 may be a compute device. The hub 106 may be associated with a first display 108. The device 110 may be associated with a second display 112. The first display 108 may provide rendered data to a first eye of a user associated with the UE 102. The second display 112 may provide rendered data to a second eye of the user associated with the UE 102. The host 104 may be associated with a data source, which may be used when providing rendered data to the first display 108 and the second display 112. The rendered data may be associated with an XR use case.

In one example, the UE 102 may include a first component and a second component. The first component may include the host 104. The second component may include the hub 106 and the device 110. For example, the second component may be a set of XR goggles or a head-mounted display. The first component may be connected to the second component via a wired connection or a wireless connection. Alternatively, the UE 102 may be a single component that includes all of the host 104, the hub 106, and the device 110.

In one example, the host 104 may deliver several data streams to the hub 106 and the device 110 via one or more USB4 connections between the host 104 and the hub 106 and/or between the hub 106 and the device 110. The first display 108 may be driven by the hub 106 (first chip) and the second display 112 may be driven by the device 110 (second chip). Alternatively, the first display 108 and the second display 112 may be driven by the same chip (e.g., the hub 106). The several data streams may include a first data stream associated with the first display 108 and a second data stream associated with the second display 112. The first data stream may be provided to the first eye of the user, and the second data stream may be provided to the second eye of the user. The first data stream and the second data stream may be delivered from the data source (e.g., a same original source), which may be associated with the host 104. Further, an accurate time synchronization may be performed over USB4 to reconstruct a display video clock frequency.

As indicated above, FIG. 1 is provided as an example. Other examples may differ from what is described with regard to FIG. 1. The number and arrangement of devices shown in FIG. 1 are provided as an example. In practice, there may be additional devices, fewer devices, different devices, or differently arranged devices than those shown in FIG. 1. Furthermore, two or more devices shown in FIG. 1 may be implemented within a single device, or a single device shown in FIG. 1 may be implemented as multiple, distributed devices. Additionally, or alternatively, a set of devices (e.g., one or more devices) shown in FIG. 1 may perform one or more functions described as being performed by another set of devices shown in FIG. 1.

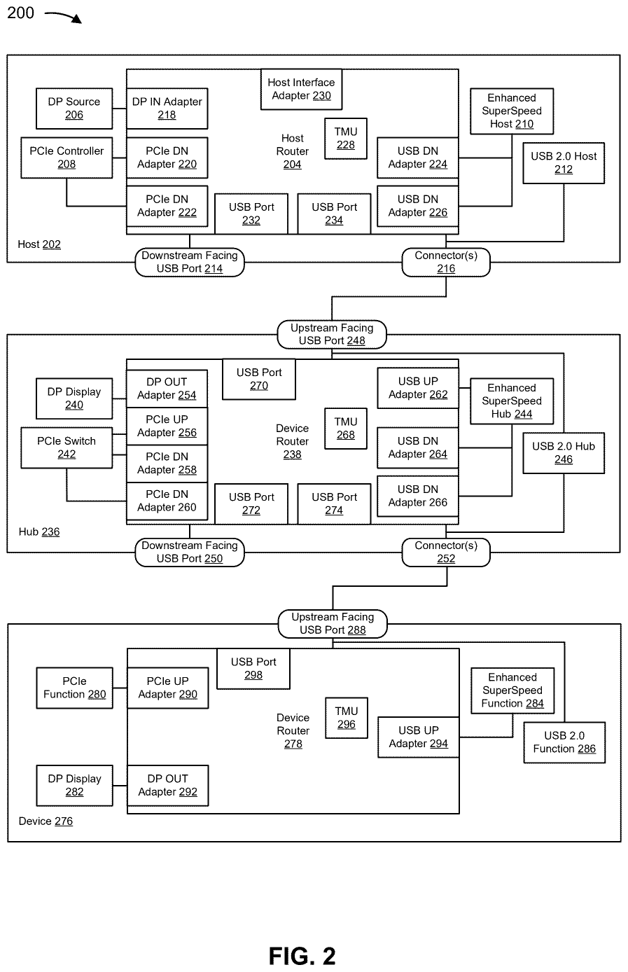

FIG. 2 is a diagram illustrating an example 200 associated with a dual bus system architecture for providing XR functionalities via multiple displays, in accordance with the present disclosure. The dual bus system architecture may be in accordance with a USB4 standard.

As shown in FIG. 2, a host 202 (which corresponds to host 104, as shown in FIG. 1) may be associated with (e.g., coupled to) a hub 236 (which corresponds to hub 106, as shown in FIG. 1). The hub 236 may be associated with (e.g., coupled to) a device 276 (which corresponds to device 110, as shown in FIG. 1). The host 202 may be a USB4 host, the hub 236 may be a USB4 hub, and the device 276 may be a USB4 device. The host 202, the hub 236, and the device 276 may be associated with a UE (e.g., UE 102, as shown in FIG. 1).

The host 202 (e.g., the USB4 host) may include a host router 204, a DisplayPort (DP) source 206, a PCIe controller 208, an enhanced SuperSpeed host 210 (e.g., a USB 3.0 host), a USB 2.0 host 212, a downstream facing port 214, and one or more connectors 216. The enhanced SuperSpeed host 210 may have improved capabilities (e.g., transfer speed) as compared to the USB 2.0 host 212. The host 202 may not include any upstream facing ports. The host router 204 may map tunneled protocol traffic to USB4 packets and may route packets through a USB4 fabric. For example, the USB4 fabric may be associated with the host 202, the hub 236, and the device 276. The host router 204 may distribute and synchronize time through the USB4 fabric via a time management unit (TMU) 228. The host router 204 may contain up to 64 adapters, where each adapter may provide an interface between the host router 204 and an external entity.

The host router 204 may include a DP IN adapter 218, a PCIe downstream (DN) adapter 220, a PCIe DN adapter 222, a USB DN adapter 224 (e.g., a universal serial bus 3(USB3 ) DN adapter), a USB DN adapter 226 (e.g., a USB3 DN adapter), the TMU 228, a host interface adapter 230, a USB port 232 (e.g., USB4 port), and a USB port 234 (e.g., USB4 port). The DP IN adapter 218 may be associated with the DP source 206. The PCIe DN adapter 220 and the PCIe DN adapter 222 may be associated with the PCIe controller 208. The USB DN adapter 224 and the USB DN adapter 226 may be associated with the host 210. The USB port 232, the host 210, and the host 212 may be associated with the downstream facing port 214. The USB port 234, the host 210, and the host 212 may be associated with the one or more connectors 216. The one or more connectors 216 may include one or more USB Type-C connectors. The one or more USB Type-C connectors may be associated with a composite cable. The composite cable may be associated with a USB4 bus and a USB 2.0 bus.

The hub 236 (e.g., the USB4 hub) may include a device router 238, a DP display 240, a PCIe switch 242, an enhanced SuperSpeed hub 244 (e.g., a USB 3.0 hub), a USB 2.0 hub 246, an upstream facing port 248, a downstream facing port 250, and one or more connectors 252. The enhanced SuperSpeed hub 244 may have improved capabilities (e.g., transfer speed) as compared to the USB 2.0 hub 246. The upstream facing port 248 may be coupled to the one or more connectors 216 associated with the host 202.

The device router 238 may include a DP OUT adapter 254, a PCIe upstream (UP) adapter 256, a PCIe DN adapter 258, a PCIe DN adapter 260, a USB UP adapter 262 (e.g., USB3 UP adapter), a USB DN adapter 264 (e.g., USB3 DN adapter), a USB DN adapter 266 (e.g., USB3 DN adapter), a TMU 268, a USB port 270 (e.g., USB4 port), a USB port 272 (e.g., USB4 port), and a USB port 274 (e.g., USB4 port). The DP OUT adapter 254 may be associated with the DP display 240. The PCIe UP adapter 256, the PCIe DN adapter 258, and the PCIe DN adapter 260 may be associated with the PCIe switch 242. The USB UP adapter 262, the USB DN adapter 264, and the USB DN adapter 266 may be associated with the hub 244. The USB port 272, the hub 244, and the hub 246 may be associated with the downstream facing port 250. The USB port 274, the host hub, and the hub 246 may be associated with the one or more connectors 252. The hub 246 may also be associated with the upstream facing port 248.

The device 276 may include a device router 278, a PCIe function 280, a DP display 282, an enhanced SuperSpeed function 284, a USB 2.0 function 286, and an upstream facing port 288. The upstream facing port 288 may be coupled to the one or more connectors 252 associated with the hub 236. The device 276 may not include any downstream facing ports.

The device router 278 may include a PCIe UP adapter 290, a DP OUT adapter 292, a USB UP adapter 294 (e.g., USB3 UP adapter), a TMU 296, and a USB port 298 (e.g., USB4 port). The PCIe UP adapter 290 may be associated with the PCIe function 280. The DP OUT adapter 292 may be associated with the DP display 282. The USB UP adapter 294 may be associated with the function 284. The USB port 298, the function 284, and the function 286 may be associated with the upstream facing port 288.

In the USB4 standard, one or more cable buses may support a data exchange between the host 202 (e.g., an external host or compute device) and a wide range of simultaneously accessible peripherals, which may include the device 276. The USB4 standard may also allow the host 202 to set up data exchange between compatible peripherals. Attached peripherals may share a bandwidth as configured by the host 202. The one or more cable buses may allow peripherals to be attached, configured, and/or used while the host 202 and other peripherals are in operation. The USB4 standard may support a connection-oriented, tunneling architecture that combines multiple protocols onto a single physical interface, such that a total speed and performance of the USB4 fabric may be dynamically shared between entities. The USB4 standard may allow for USB data transfers to operate in parallel with other independent protocols specific to display, load/store, and/or host-to-host interfaces. Time synchronization across the USB4 fabric may use distributed TMUs (e.g., TMU 228, TMU 268, and TMU 296) associated with each router (e.g., the host router 204, the device router 238, and the device router 278).

In one example, the hub 236 may be associated with the DP display 240 (which corresponds to first display 108, as shown in FIG. 1), and the device 276 may be associated with the DP display 282 (which corresponds to second display 112, as shown in FIG. 1). The host 202 may include the DP source 206, which may provide a source for a first data stream provided to the DP display 240 associated with the hub 236 and a second data stream provided to the DP display 282 associated with the device 276. The first data stream and the second data stream may be associated with an XR use case.

The dual bus system architecture may support a time synchronization protocol, which may provide a mechanism for synchronizing real-time clocks and absolute time of connected routers (e.g., the host router 204, the device router 238, and the device router 278) to a high degree of accuracy and precision. The host router 204 and the device router 238, each with one or more downstream facing USB ports, may support the time synchronization protocol. The device router 278, without any downstream facing USB port, may also support the time synchronization protocol. The time synchronization protocol may be a distributed protocol that defines a manner in which the real-time clocks in the USB4 fabric synchronize with each other. The real-time clocks may be organized into a hierarchy with the host router 204 at the top of the hierarchy determining a reference time for an entire domain. Clock synchronization may be achieved by exchanging ordered sets and time synchronization packets, where downstream hubs, such as the hub 236, and downstream peripheral devices, such as the device 276, may use both local timestamps and timing information in the time synchronization packets to adjust their respective real-time clocks to the time of the host router 204.

As indicated above, FIG. 2 is provided as an example. Other examples may differ from what is described with regard to FIG. 2. The number and arrangement of devices shown in FIG. 2 are provided as an example. In practice, there may be additional devices, fewer devices, different devices, or differently arranged devices than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) shown in FIG. 2 may perform one or more functions described as being performed by another set of devices shown in FIG. 2.

A USB4 standard may support accurate time synchronization between a host, a hub, and a device, which may allow for a display clock frequency reconstruction. In the USB4 standard, the display clock frequency reconstruction may be based on time synchronization packets that are indicated in a data stream. The time synchronization packets may indicate timing information, which may be used for the display clock frequency reconstruction. The time synchronization packets may be embedded in the data stream because USB4 devices do not typically transmit a separate clock signal. The display clock frequency reconstruction may be critical for data transmission, display outputs, and/or data integrity in USB4 applications. For example, USB4 devices may rely on display clock frequency reconstruction to maintain synchronized data transmission.

However, the USB4 standard may not provide a frame synchronization capability between multiple data streams. The USB4 standard may allow for accurate display clock frequency reconstruction, but may not support the frame synchronization capability between the multiple data streams. For example, the host may provide a first data stream and a second data stream. The first data stream may be displayed via a display associated with the hub and the second data stream may be displayed via a display associated with the device. The first data stream and the second data stream may be associated with an XR use case. A user may use a first eye to view the first data stream and a second eye to view the second data stream. Without the frame synchronization capability, the first data stream may not be frame synchronized with the second data stream, such that the user may view slightly different content on the display associated with the hub versus the display associated with the device. A lack of ability to synchronize the frames or presentation times of displayed content may result in a degraded user experience when the user is interacting with XR devices, especially in low frame-rate contexts.

Frame synchronization may be used to ensure that a frequency of a display matches a frequency of a target (e.g., no under-runs or over-runs in display content due to a display stream clock running too fast or too slow, as clock frequencies may be changed a little from a nominal frequency or over time). Frame synchronization between displays may not directly result from clock frequencies being synchronized, as the frame synchronization may also require synchronizing a phase of display streams and not only their frequency. For example, two target displays may be synchronized to run at 30 frames per second plus an epsilon to match a stream source frequency, but at the same time, a video frame in one display may start before a video frame in another display since the phase (or offset) for frame events may not be synchronized.

In various aspects of techniques and apparatuses described herein, a first device, such as a hub (e.g., a USB4 hub), may identify a timing associated with a third device, such as a host (e.g., a USB4 host). The third device may be communicatively coupled to the first device. The timing may be a reference timing that is maintained at the first device. The timing may also be maintained at a second device, such as a device (e.g., USB4 device). The second device may be communicatively coupled to the first device. The second device may be communicatively coupled to the third device via the first device. The first device may perform a video frame synchronization between a first display associated with the first device and a second display associated with the second device, based at least in part on the timing associated with the third device. The video frame synchronization may be between a first data stream and a second data stream, where the first data stream may be displayed via the first display and the second data stream may be displayed via the second display. The video frame synchronization may include a synchronization between specific display events in relation to the first display and the second display, where the specific display events may include a frame start event and/or a blank start event.

In some aspects, when performing the video frame synchronization, the first device may send, to the second device, a frame synchronization indication of the timing associated with the third device and/or a presentation timestamp, where the video frame synchronization may be based at least in part on the frame synchronization indication. In some aspects, the frame synchronization indication may be a non-USB4 indication. The non-USB4 indication may be sent between a GPIO entity associated with the first device and a GPIO entity associated with the second device. In some aspects, the frame synchronization indication may be a USB4 indication. The USB4 indication may be sent between a USB4 port associated with the first device and a USB4 port associated with the second device. The USB4 indication may be conveyed via a dedicated USB4 packet, or the USB4 indication may be embedded as a field in an USB4 packet.

In some aspects, the first device may be the USB4 hub, the second device may be the USB4 device, and the third device may be the USB4 host. Alternatively, the first device may be a first USB4 hub, the second device may be a second USB4 hub, and the third device may be the USB4 host. In some aspects, the video frame synchronization may be based at least in part on a time synchronization associated with a USB4 standard. In some aspects, the first device, the second device, and the third device may be associated with a UE, where the UE may be capable of supporting an XR functionality.

In some aspects, by enabling the video frame synchronization using the timing associated with the third device, the first device may perform the video frame synchronization between the first display associated with the first device and the second display associated with the second device. When a user is viewing the first display via a first eye and the second display via a second eye, the first display may appear to be frame synchronized with the second display, thereby improving an overall system performance. The first device, the second device, and/or the third device may support an ability to synchronize frames and/or presentation times of displayed content, especially in low frame-rate contexts, which may improve the overall system performance. In some aspects, while external time synchronization mechanisms may be employed, such approaches may add complexity over a USB4 based time synchronization. Further, such approaches may lead to higher costs and/or decreased accuracy. An ability to achieve the video frame synchronization while still using the USB4 standard may reduce an overall complexity, thereby resulting in the improved overall system performance.

In some aspects, the first device may be the hub, the second device may be the device, and the third device may be the hub. The hub may include one or more displays, and the device may include one or more displays. The one or more displays associated with the hub may be synchronized with the one or more displays associated with the device based at least in part on a host time delivered over USB4. In other words, two or more displays in the hub and the device may be synchronized based at least in part on the host time. A video frame synchronization between the two or more displays may occur over USB4, or the video frame between the two or more displays synchronization may be external to USB4.

In some aspects, a first device may be a hub and a second device may be a host. The hub may include one or more displays, and the host may include one or more displays. The one or more displays associated with the hub may be synchronized with the one or more displays associated with the host based at least in part on a host time delivered over USB4. In other words, two or more displays in the hub and the host may be synchronized based at least in part on the host time. A video frame synchronization between the two or more displays may occur over USB4, or the video frame between the two or more displays synchronization may be external to USB4.

In some aspects, a first device may be a device and a second device may be a host. The device may include one or more displays, and the host may include one or more displays. The one or more displays associated with the device may be synchronized with the one or more displays associated with the host based at least in part on a host time delivered over USB4. In other words, two or more displays in the device and the host may be synchronized based at least in part on the host time. A video frame synchronization between the two or more displays may occur over USB4, or the video frame between the two or more displays synchronization may be external to USB4.

In some aspects, a first device may be a hub, a host, or a device, and the second device may be a hub, a host, or a device. The first device and the second device may be associated with separate domains. The first device may include one or more displays, and the second device may include one or more displays. The one or more displays associated with the first device may be synchronized with the one or more displays associated with the second device based at least in part on an inter-domain timing. The inter-domain timing may be a time that is maintained between separate hosts in the separate domains (inter-domain). A video frame synchronization between the one or more displays associated with the first device and the one or more displays associated with the second device may be based at least in part on the inter-domain timing, as opposed to a host time.

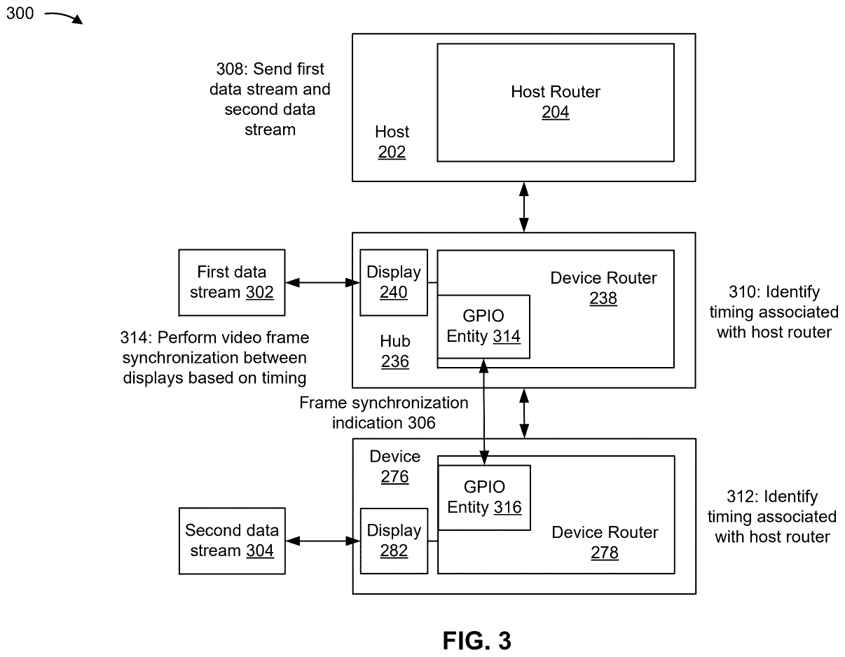

FIG. 3 is a diagram illustrating an example 300 associated with video frame synchronization between displays associated with separate devices, in accordance with the present disclosure. The example 300 may include a host 202 (which corresponds to host 104, as shown in FIG. 1), a hub 236 (which corresponds to hub 106, as shown in FIG. 1), and a device 276 (which corresponds to device 110, as shown in FIG. 1). The host 202 may be a USB4 host, the hub 236 may be a USB4 hub, and the device 276 may be a USB4 device. The host 202, the hub 236, and the device 276 may be associated with a UE (e.g., UE 102, as shown in FIG. 1), where the UE may be capable of providing one or more XR functionalities. The host 202 may include a host router 204, the hub 236 may include a device router 238, and the device 276 may include a device router 278, where respective routers may allow the host 202, the hub 236, and the device 276 to communicate with each other.

As shown by reference number 308, the host 202 may send, via the host router 204, a first data stream 302 and a second data stream 304 to the hub 236. The host 202 may obtain the first data stream 302 and the second data stream 304 from a source associated with the host 202. The first data stream 302 and the second data stream 304 may each include a plurality of frames. The hub 236 may receive, via the device router 238, the first data stream 302 and the second data stream 304. The hub 236 may send, via the device router 238, the second data stream 304 to the device 276. The device 276 may receive, via the device router 278, the second data stream 304.

As shown by reference number 310, the hub 236 may identify a timing associated with the host router 204. The timing may be a USB4 host router reconstructed time. In other words, the timing may be a reference timing that is set by the host 202. The host 202 may provide one or more time synchronization packets to the hub 236. The hub 236 may synchronize its local timing to the timing associated with the host router 204, which may be based at least in part on the one or more time synchronization packets. In other words, the hub 236 may use the one or more time synchronization packets to adjust a local real-time clock to the timing of the host router 204.

As shown by reference number 312, the device 276 may identify the timing associated with the host router 204. The timing may be the USB4 host router reconstructed time. In other words, the timing may be the reference timing that is set by the host 202. The host 202 may provide one or more time synchronization packets to the device 276 via the hub 236. The device 276 may synchronize its local timing to the timing associated with the host router 204, which may be based at least in part on the one or more time synchronization packets. In other words, the device 276 may use the one or more time synchronization packets to adjust a local real-time clock to the timing of the host router 204. The one or more time synchronization packets may ensure that both the hub 236 and the device 276 are synchronized with the timing associated with the host router 204.

In some aspects, the timing associated with the host router 204 may be an inter-domain timing. The inter-domain timing may be a timing that is maintained between separate hosts in separate domains (inter-domain). In this example, the host 202, the hub 236, and/or the device 276 may be associated with the separate domains. The inter-domain timing may be maintained between the host 202 and another host in another domain, and the inter-domain timing may be identified by the hub 236 and/or the device 276.

As shown by reference number 314, the hub 236 and/or the device 276 may perform a video frame synchronization between respective displays, which may be based at least in part on the timing associated with the host router 204. As part of the video frame synchronization, the hub 236 may provide the first data stream 302 to a display 240 (which corresponds to a first display 108, as shown in FIG. 1). The device 276 may provide the second data stream 304 to a display 282 (which corresponds to a second display 112, as shown in FIG. 1). In one example, the display 240 and the display 282 may display content for each respective eye of a user associated with the UE. For example, the user may use a first eye to view video content associated with the first data stream 302 on the display 240, and the user may use a second eye to view video content associated with the second data stream 304 on the display 282. In this example, to improve a user experience, the USB4 host router reconstructed time, which may be maintained at both the hub 236 and the device 276, may be used to perform the video frame synchronization between separate display streams delivered over a USB4 protocol.

In some aspects, as part of the video frame synchronization, the hub 236 may exchange, with the device 276, a frame synchronization indication 306 of the timing associated with the host router 204 and/or a presentation timestamp. The frame synchronization indication 306 may be generated at the hub 236 and/or the device 276, or alternatively, the frame synchronization indication 306 may be generated at the host 202 and then conveyed to the hub 236 and/or the device 276. The frame synchronization indication 306 may be a non-USB4 indication. For example, the frame synchronization indication 306 may be exchanged between a GPIO entity 314 of the device router 238 associated with the hub 236 and a GPIO entity 316 of the device router 278 associated with the device 276. In this example, the frame synchronization indication 306 may not be exchanged via USB4 ports of the hub 236 and the device 276, respectively. The frame synchronization indication 306 may enable a synchronization between specific display events in relation to the display 240 and the display 282, where the specific display events may include a frame start event or a blank start event.

For example, the presentation timestamp may indicate a time that a specific frame, of the first data stream 302 and the second data stream 304, is to be displayed so that respective frames of the first data stream 302 and the second data stream 304 are in synchronization with each other. The presentation timestamp may define an exact moment when a video frame is to be displayed (rendered) on a screen. Since both the hub 236 and the device 276 maintain the timing of the host router 204 (and are thus synchronized with each other in terms of timing), the hub 236 may display the frame at the presentation timestamp in synchronization with the device 276 displaying the frame at the presentation timestamp.

As another example, the presentation timestamp may indicate a time that a specific frame, of the first data stream 302 and the second data stream 304, is to be blanked (or hidden) so that respective frames of the first data stream 302 and the second data stream 304 are in synchronization with each other. Since both the hub 236 and the device 276 maintain the timing of the host router 204 (and are thus synchronized with each other), the hub 236 may blank the frame at the presentation timestamp in synchronization with the device 276 blanking the frame at the presentation timestamp. In other words, in both examples, the presentation timestamps may be interpreted similarly by the hub 236 and the device 276 since both the hub 236 and the device 276 maintain the same timing, which may allow for the video frame synchronization.

In some aspects, the hub 236 and the device 276 may exchange an out-of-USB4 communication of the USB4 host router reconstructed time and/or corresponding presentation time derivatives. For example, the out-of-USB4 communication may be between the GPIO entity 314 in the hub 236 and the GPIO entity 316 in the device 276. In this case, the USB4 host router reconstructed time maintained at the hub 236 and at the device 276 may be exposed externally from a USB4 domain to one or more external entities generating the frame synchronization indication 306. The one or more external entities may be respective GPIO entities (e.g., respective GPIO pins) in the hub 236 and the device 276. The frame synchronization indication 306 may be sent to separate display transmitters associated with the display 240 and the display 282, respectively, which may be based at least in part on preconfigured frame start event properties and/or negotiated frame start event properties. The corresponding presentation time derivatives may be used by respective displays in the hub 236 and the device 276 for synchronizing the specific display events, such as a frame start and a blanking start. The specific display events may also be related to a frame end, a blanking end, and/or a start of a specific video line.

In some aspects, the out-of-USB4 communication may be a non-USB4 indication (e.g., an out-of-band indication). The non-USB4 indication may be sent between the GPIO entity 314 in the hub 236 and the GPIO entity 316 in the device 276. In some aspects, the video frame synchronization may be based at least in part on a pre-configuration or any other non-USB4 in-band agreement that uses the USB4 host router reconstructed time and triggers synchronization events between two or more displays in a manner external to USB4 (but still uses a USB4 accurate clock reconstruction for phase synchronization). For example, when the USB4 host router reconstructed time in both the device router 238 and the device router 278 reaches a certain value (e.g., a preconfigured value or a value based at least in part on an indication delivered externally), a frame start event in each of the display 240 and the display 282 may be triggered.

In some aspects, certain timing events (e.g., frame start, frame end, blanking start, and/or blanking end) may be within a frame. The frame (e.g., video frame) may be composed of various periodic timing events, and the frame itself may repeat as well. The frame may be composed of scan lines that do not contain video image data (Vblank lines), and scan lines that do contain video image data (Vactive lines). Lines included in the Vactive region may have a period of Hblank and a period of Hactive. Various display standards may differ in their definition of “Frame Start”. For example, a first display standard may use a start of Vblank (e.g., DP uses a start of vertical blanking (start of Vblank)), a second display standard may use a start of Vactive, and a third display standard may use a Vsync event on a specific line in a Vblank region.

In some aspects, a frame start and a blanking start may be identical events. Examples of display events may include a first vertical blanking line start, a last vertical blanking line start, a first vertical active video line start, a last vertical active video line start, and/or a specific scan line start. When more than one synchronization event is present per frame, the frame start and/or the blanking start may be defined in a more granular manner as they may correspond to the same event.

An alternative is to rely on high frame rates and a tolerance of a lack of frame synchronization, or an out-of-band separate time synchronization between devices that does not utilize an already supported and highly accurate USB4 time synchronization mechanism. As a result, the alternative approaches may involve using additional pins (e.g., dedicated pulse pins) and/or achieving a lower synchronization accuracy as compared to USB4. In some aspects, by utilizing the time synchronization in the USB4 standard and incorporating the frame synchronization indication 306 (e.g., a presentation timestamp), the video frame synchronization may be achieved with reduced complexity and increased accuracy, as compared to the alternative approaches.

As indicated above, FIG. 3 is provided as an example. Other examples may differ from what is described with regard to FIG. 3. The number and arrangement of devices shown in FIG. 3 are provided as an example. In practice, there may be additional devices, fewer devices, different devices, or differently arranged devices than those shown in FIG. 3. Furthermore, two or more devices shown in FIG. 3 may be implemented within a single device, or a single device shown in FIG. 3 may be implemented as multiple, distributed devices. Additionally, or alternatively, a set of devices (e.g., one or more devices) shown in FIG. 3 may perform one or more functions described as being performed by another set of devices shown in FIG. 3.

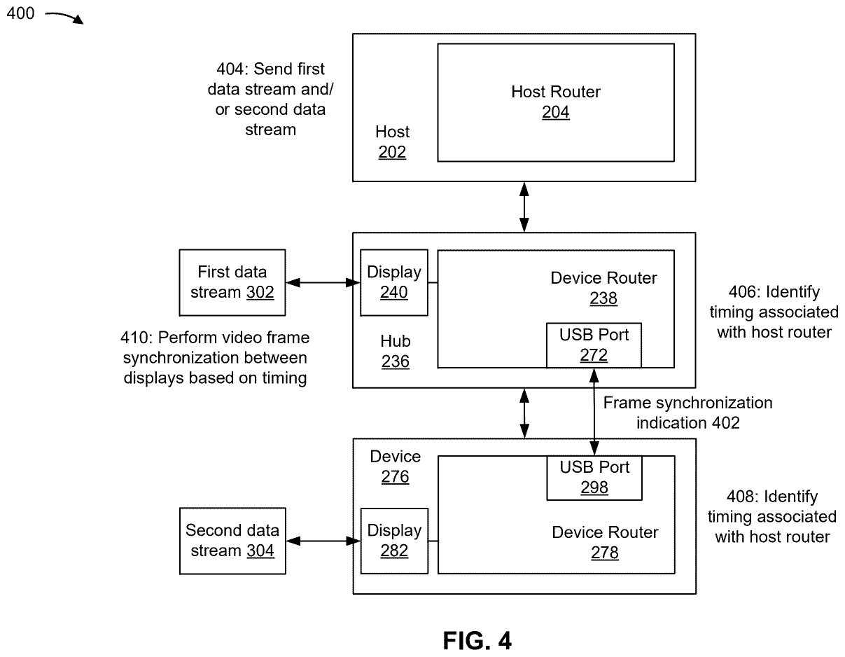

FIG. 4 is a diagram illustrating an example 400 associated with video frame synchronization between displays associated with separate devices, in accordance with the present disclosure. The example 400 may include a host 202 (which corresponds to host 104, as shown in FIG. 1), a hub 236 (which corresponds to hub 106, as shown in FIG. 1), and a device 276 (which corresponds to device 110, as shown in FIG. 1). The host 202 may be a USB4 host, the hub 236 may be a USB4 hub, and the device 276 may be a USB4 device. The host 202, the hub 236, and the device 276 may be associated with a UE (e.g., UE 102, as shown in FIG. 1), where the UE may be capable of providing one or more XR functionalities. The host 202 may include a host router 204, the hub 236 may include a device router 238, and the device 276 may include a device router 278, where respective routers may allow the host 202, the hub 236, and the device 276 to communicate with each other.

As shown by reference number 404, the host 202 may send, via the host router 204, a first data stream 302 and a second data stream 304 to the hub 236. The host 202 may obtain the first data stream 302 and the second data stream 304 from a source associated with the host 202. The first data stream 302 and the second data stream 304 may each include a plurality of frames. The hub 236 may receive, via the device router 238, the first data stream 302 and the second data stream 304. The hub 236 may send, via the device router 238, the second data stream 304, to the device 276. The device 276 may receive, via the device router 278, the second data stream 304.

As shown by reference number 406, the hub 236 may identify a timing associated with the host router 204. The timing may be a USB4 host router reconstructed time. In other words, the timing may be a reference timing that is set by the host 202. The host 202 may provide one or more time synchronization packets to the hub 236. The hub 236 may synchronize its local timing to the timing associated with the host router 204, which may be based at least in part on the one or more time synchronization packets. In other words, the hub 236 may use the one or more time synchronization packets to adjust a local real-time clock to the timing of the host router 204.

As shown by reference number 408, the device 276 may identify the timing associated with the host router 204. The timing may be the USB4 host router reconstructed time. In other words, the timing may be the reference timing that is set by the host 202. The host 202 may provide one or more time synchronization packets to the device 276 via the hub 236. The device 276 may synchronize its local timing to the timing associated with the host router 204, which may be based at least in part on the one or more time synchronization packets. In other words, the device 276 may use the one or more time synchronization packets to adjust a local real-time clock to the timing of the host router 204. The one or more time synchronization packets may ensure that both the hub 236 and the device 276 are synchronized with the timing associated with the host router 204.

In some aspects, the timing associated with the host router 204 may be an inter-domain timing. The inter-domain timing may be a timing that is maintained between separate hosts in separate domains (inter-domain). In this example, the host 202, the hub 236, and/or the device 276 may be associated with the separate domains. The inter-domain timing may be maintained between the host 202 and another host in another domain, and the inter-domain timing may be identified by the hub 236 and/or the device 276.

As shown by reference number 410, the hub 236 and/or the device 276 may perform a video frame synchronization between respective displays, which may be based at least in part on the timing associated with the host router 204. As part of the video frame synchronization, the hub 236 may provide the first data stream 302 to a display 240 (which corresponds to a first display 108, as shown in FIG. 1). The device 276 may provide the second data stream 304 to a display 282 (which corresponds to a second display 112, as shown in FIG. 1). In one example, the display 240 and the display 282 may display content for each respective eye of a user associated with the UE. For example, the user may use a first eye to view video content associated with the first data stream 302 on the display 240, and the user may use a second eye to view video content associated with the second data stream 304 on the display 282. In this example, to improve a user experience, the USB4 host router reconstructed time, which may be maintained at both the hub 236 and the device 276, may be used to perform the video frame synchronization between separate display streams delivered over a USB4 protocol.

In some aspects, as part of the video frame synchronization, the hub 236 may exchange, with the device 276, a frame synchronization indication 402 of the timing associated with the host router 204 and/or a presentation timestamp. The frame synchronization indication 402 may be a USB4 indication. For example, the frame synchronization indication 402 may be exchanged between a USB port 272 (e.g., USB4 port) of the device router 238 associated with the hub 236 and a USB port 298 (e.g., USB4 port) of the device router 278 associated with the device 276. The frame synchronization indication 402 may be exchanged via a dedicated USB4 packet, or the frame synchronization indication 402 may be embedded as a field in an USB4 packet. In this example, the frame synchronization indication 402 may not be exchanged via GPIO entities of the hub 236 and the device 276, respectively. The frame synchronization indication 402 may enable a synchronization between specific display events in relation to the display 240 and the display 282, where the specific display events may include a frame start event or a blank start event.

For example, the presentation timestamp may indicate a time that a specific frame, of the first data stream 302 and the second data stream 304, is to be displayed so that respective frames of the first data stream 302 and the second data stream 304 are in synchronization with each other. Since both the hub 236 and the device 276 maintain the timing of the host router 204 (and are thus synchronized with each other), the hub 236 may display the frame at the presentation timestamp in synchronization with the device 276 displaying the frame at the presentation timestamp.

As another example, the presentation timestamp may indicate a time that a specific frame, of the first data stream 302 and the second data stream 304, is to be blanked (or hidden) so that respective frames of the first data stream 302 and the second data stream 304 are in synchronization with each other. Since both the hub 236 and the device 276 maintain the timing of the host router 204 (and are thus synchronized with each other), the hub 236 may blank the frame at the presentation timestamp in synchronization with the device 276 blanking the frame at the presentation timestamp. In other words, in both examples, the presentation timestamps may be interpreted similarly by the hub 236 and the device 276 since both the hub 236 and the device 276 maintain the same timing, which may allow for the video frame synchronization.

In some aspects, the hub 236 and the device 276 may exchange a USB4 packet or a packet field carrying the presentation timestamp utilizing a USB4 time synchronization ability. The presentation timestamp may be sent over USB4 in a time domain of the USB4 host router reconstructed time, for example, by using the dedicated USB4 packet or by embedding the presentation timestamp in the USB4 packet as another field. The presentation timestamp may be used by respective displays in the hub 236 and the device 276 for synchronizing the specific display events, such as a frame start and a blanking start.

As indicated above, FIG. 4 is provided as an example. Other examples may differ from what is described with regard to FIG. 4. The number and arrangement of devices shown in FIG. 4 are provided as an example. In practice, there may be additional devices, fewer devices, different devices, or differently arranged devices than those shown in FIG. 4. Furthermore, two or more devices shown in FIG. 4 may be implemented within a single device, or a single device shown in FIG. 4 may be implemented as multiple, distributed devices. Additionally, or alternatively, a set of devices (e.g., one or more devices) shown in FIG. 4 may perform one or more functions described as being performed by another set of devices shown in FIG. 4.

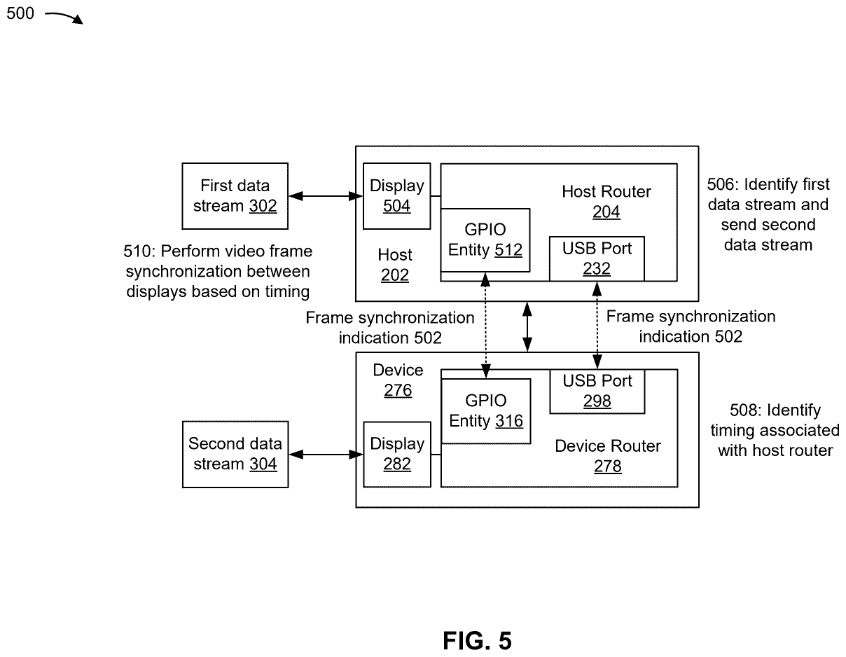

FIG. 5 is a diagram illustrating an example 500 associated with video frame synchronization between displays associated with separate devices, in accordance with the present disclosure. The example 500 may include a host 202 (which corresponds to host 104, as shown in FIG. 1) and a device 276 (which corresponds to device 110, as shown in FIG. 1). The host 202 may be a USB4 host and the device 276 may be a USB4 device. The host 202 and the device 276 may be associated with a UE (e.g., UE 102, as shown in FIG. 1), where the UE may be capable of providing one or more XR functionalities. The host 202 may include a host router 204, and the device 276 may include a device router 278, where respective routers may allow the host 202 and the device 276 to communicate with each other.

As shown by reference number 506, the host 202 may identify a first data stream 302 and send, via the host router 204, a second data stream 304 to the device 276. The host 202 may obtain the first data stream 302 and the second data stream 304 from a source associated with the host 202. The first data stream 302 and the second data stream 304 may each include a plurality of frames. The device 276 may receive, via the device router 278, the second data stream 304.

As shown by reference number 508, the device 276 may identify a timing associated with the host router 204 (or an inter-domain timing). The timing may be a USB4 host router reconstructed time. In other words, the timing may be a reference timing that is set by the host 202. The host 202 may provide one or more time synchronization packets to the device 276 via the hub 236. The device 276 may synchronize its local timing to the timing associated with the host router 204, which may be based at least in part on the one or more time synchronization packets. In other words, the device 276 may use the one or more time synchronization packets to adjust a local real-time clock to the timing of the host router 204. The one or more time synchronization packets may ensure that the device 276 is synchronized with the timing associated with the host router 204.

As shown by reference number 510, the host 202 and/or the device 276 may perform a video frame synchronization between respective displays, which may be based at least in part on the timing associated with the host router 204. As part of the video frame synchronization, the host 202 may provide the first data stream 302 to a display 504. The device 276 may provide the second data stream 304 to a display 282 (which corresponds to a second display 112, as shown in FIG. 1). In one example, the display 504 and the display 282 may display content for each respective eye of a user associated with the UE. For example, the user may use a first eye to view video content associated with the first data stream 302 on the display 504, and the user may use a second eye to view video content associated with the second data stream 304 on the display 282. In this example, to improve a user experience, the USB4 host router reconstructed time, which may be maintained at the device 276, may be used to perform the video frame synchronization between separate display streams delivered over a USB4 protocol.

In some aspects, as part of the video frame synchronization, the host 202 may exchange, with the device 276, a frame synchronization indication 502 of the timing associated with the host router 204 and/or a presentation timestamp. The frame synchronization indication 502 may be generated at the host 202 and/or the device 276. The frame synchronization indication 502 may be a non-USB4 indication. For example, the frame synchronization indication 502 may be exchanged between a GPIO entity 512 of the host router 204 associated with the host 202 and a GPIO entity 316 of the device router 278 associated with the device 276. The frame synchronization indication 502 may enable a synchronization between specific display events in relation to the display 504 and the display 282, where the specific display events may include a frame start event or a blank start event. In some aspects, the frame synchronization indication 502 may be a USB4 indication. For example, the frame synchronization indication 502 may be exchanged between a USB port 232 (e.g., USB4 port) of the host router 204 associated with the host 202 and a USB port 298 (e.g., USB4 port) of the device router 278 associated with the device 276. The frame synchronization indication 502 may be exchanged via a dedicated USB4 packet, or the frame synchronization indication 502 may be embedded as a field in an USB4 packet.

As indicated above, FIG. 5 is provided as an example. Other examples may differ from what is described with regard to FIG. 5. The number and arrangement of devices shown in FIG. 5 are provided as an example. In practice, there may be additional devices, fewer devices, different devices, or differently arranged devices than those shown in FIG. 5. Furthermore, two or more devices shown in FIG. 5 may be implemented within a single device, or a single device shown in FIG. 5 may be implemented as multiple, distributed devices. Additionally, or alternatively, a set of devices (e.g., one or more devices) shown in FIG. 5 may perform one or more functions described as being performed by another set of devices shown in FIG. 5.

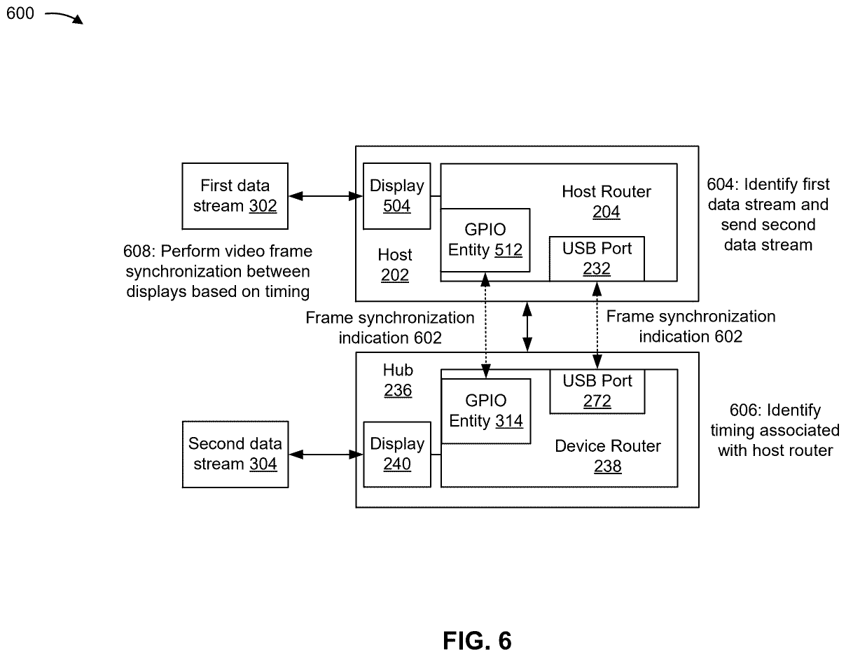

FIG. 6 is a diagram illustrating an example 600 associated with video frame synchronization between displays associated with separate devices, in accordance with the present disclosure. The example 600 may include a host 202 (which corresponds to host 104, as shown in FIG. 1) and a hub 236 (which corresponds to hub 106, as shown in FIG. 1). The host 202 may be a USB4 host and the hub 236 may be a USB4 hub. The host 202 and the hub 236 may be associated with a UE (e.g., UE 102, as shown in FIG. 1), where the UE may be capable of providing one or more XR functionalities. The host 202 may include a host router 204, and the hub 236 may include a device router 238, where respective routers may allow the host 202 and the hub 236 to communicate with each other.

As shown by reference number 506, the host 202 may identify a first data stream 302 and send, via the host router 204, a second data stream 304 to the hub 236. The host 202 may obtain the first data stream 302 and the second data stream 304 from a source associated with the host 202. The first data stream 302 and the second data stream 304 may each include a plurality of frames. The hub 236 may receive, via the device router 238, the second data stream 304.

As shown by reference number 606, the hub 236 may identify a timing associated with the host router 204 (or an inter-domain timing). The timing may be a USB4 host router reconstructed time. In other words, the timing may be a reference timing that is set by the host 202. The host 202 may provide one or more time synchronization packets to the hub 236. The hub 236 may synchronize its local timing to the timing associated with the host router 204, which may be based at least in part on the one or more time synchronization packets. In other words, the hub 236 may use the one or more time synchronization packets to adjust a local real-time clock to the timing of the host router 204.

As shown by reference number 608, the host 202 and/or the hub 236 may perform a video frame synchronization between respective displays, which may be based at least in part on the timing associated with the host router 204. As part of the video frame synchronization, the host 202 may provide the first data stream 302 to a display 504. The hub 236 may provide the second data stream 304 to a display 240 (which corresponds to a first display 108, as shown in FIG. 1). In one example, the display 504 and the display 240 may display content for each respective eye of a user associated with the UE. For example, the user may use a first eye to view video content associated with the first data stream 302 on the display 504, and the user may use a second eye to view video content associated with the second data stream 304 on the display 240. In this example, to improve a user experience, the USB4 host router reconstructed time, which may be maintained at the hub 236, may be used to perform the video frame synchronization between separate display streams delivered over a USB4 protocol.

In some aspects, as part of the video frame synchronization, the host 202 may exchange, with the hub 236, a frame synchronization indication 602 of the timing associated with the host router 204 and/or a presentation timestamp. The frame synchronization indication 602 may be generated at the host 202 and/or the hub 236. The frame synchronization indication 602 may be a non-USB4 indication. For example, the frame synchronization indication 602 may be exchanged between a GPIO entity 512 of the host router 204 associated with the host 202 and a GPIO entity 314 of the device router 238 associated with the hub 236. The frame synchronization indication 602 may enable a synchronization between specific display events in relation to the display 504 and the display 240, where the specific display events may include a frame start event or a blank start event. In some aspects, the frame synchronization indication 602 may be a USB4 indication. For example, the frame synchronization indication 602 may be exchanged between a USB port 232 (e.g., USB4 port) of the host router 204 associated with the host 202 and a USB port 272 (e.g., USB4 port) of the device router 238 associated with the hub 236. The frame synchronization indication 602 may be exchanged via a dedicated USB4 packet, or the frame synchronization indication 602 may be embedded as a field in an USB4 packet.

As indicated above, FIG. 6 is provided as an example. Other examples may differ from what is described with regard to FIG. 6. The number and arrangement of devices shown in FIG. 6 are provided as an example. In practice, there may be additional devices, fewer devices, different devices, or differently arranged devices than those shown in FIG. 6. Furthermore, two or more devices shown in FIG. 6 may be implemented within a single device, or a single device shown in FIG. 6 may be implemented as multiple, distributed devices. Additionally, or alternatively, a set of devices (e.g., one or more devices) shown in FIG. 6 may perform one or more functions described as being performed by another set of devices shown in FIG. 6.

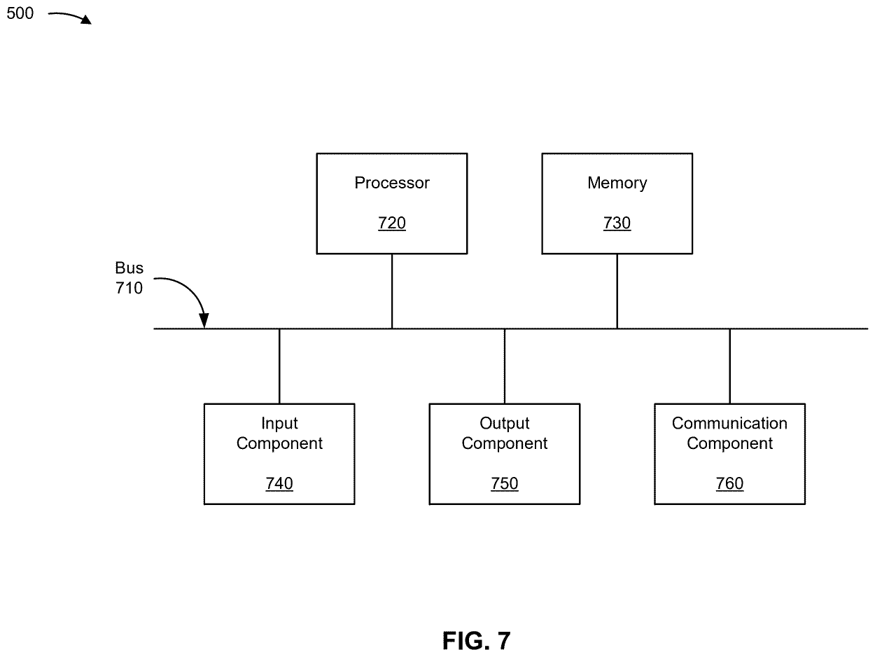

FIG. 7 is a diagram of example components of a device 700 associated with video frame synchronization between displays associated with separate devices. The device 700 may correspond to a first device (e.g., hub 236, device 276, or host 202). Alternatively, the device 700 may correspond to a second device (e.g., hub 236, device 276, or host 202) or a third device (e.g., hub 236, device 276, or host 202). In some implementations, the device may include one or more devices 700 and/or one or more components of the device 700. As shown in FIG. 7, the device 700 may include a bus 710, a processor 720, a memory 730, an input component 740, an output component 750, and/or a communication component 760.

The bus 710 may include one or more components that enable wired and/or wireless communication among the components of the device 700. The bus 710 may couple together two or more components of FIG. 7, such as via operative coupling, communicative coupling, electronic coupling, and/or electric coupling. For example, the bus 710 may include an electrical connection (e.g., a wire, a trace, and/or a lead) and/or a wireless bus. The processor 720 may include a central processing unit, a graphics processing unit, a microprocessor, a controller, a microcontroller, a digital signal processor, a field-programmable gate array, an application-specific integrated circuit, and/or another type of processing component. The processor 720 may be implemented in hardware, firmware, or a combination of hardware and software. In some implementations, the processor 720 may include one or more processors capable of being programmed to perform one or more operations or processes described elsewhere herein.

The memory 730 may include volatile and/or nonvolatile memory. For example, the memory 730 may include random access memory (RAM), read only memory (ROM), a hard disk drive, and/or another type of memory (e.g., a flash memory, a magnetic memory, and/or an optical memory). The memory 730 may include internal memory (e.g., RAM, ROM, or a hard disk drive) and/or removable memory (e.g., removable via a universal serial bus connection). The memory 730 may be a non-transitory computer-readable medium. The memory 730 may store information, one or more instructions, and/or software (e.g., one or more software applications) related to the operation of the device 700. In some implementations, the memory 730 may include one or more memories that are coupled (e.g., communicatively coupled) to one or more processors (e.g., processor 720), such as via the bus 710. Communicative coupling between a processor 720 and a memory 730 may enable the processor 720 to read and/or process information stored in the memory 730 and/or to store information in the memory 730.

The input component 740 may enable the device 700 to receive input, such as user input and/or sensed input. For example, the input component 740 may include a touch screen, a keyboard, a keypad, a mouse, a button, a microphone, a switch, a sensor, a global positioning system sensor, a global navigation satellite system sensor, an accelerometer, a gyroscope, and/or an actuator. The output component 750 may enable the device 700 to provide output, such as via a display, a speaker, and/or a light-emitting diode. The communication component 760 may enable the device 700 to communicate with other devices via a wired connection and/or a wireless connection. For example, the communication component 760 may include a receiver, a transmitter, a transceiver, a modem, a network interface card, and/or an antenna.

The device 700 may perform one or more operations or processes described herein. For example, a non-transitory computer-readable medium (e.g., memory 730) may store a set of instructions (e.g., one or more instructions or code) for execution by the processor 720. The processor 720 may execute the set of instructions to perform one or more operations or processes described herein. In some implementations, execution of the set of instructions, by one or more processors 720, causes the one or more processors 720 and/or the device 700 to perform one or more operations or processes described herein. In some implementations, hardwired circuitry may be used instead of or in combination with the instructions to perform one or more operations or processes described herein. Additionally, or alternatively, the processor 720 may be configured to perform one or more operations or processes described herein. Thus, implementations described herein are not limited to any specific combination of hardware circuitry and software.

The number and arrangement of components shown in FIG. 7 are provided as an example. The device 700 may include additional components, fewer components, different components, or differently arranged components than those shown in FIG. 7. Additionally, or alternatively, a set of components (e.g., one or more components) of the device 700 may perform one or more functions described as being performed by another set of components of the device 700.

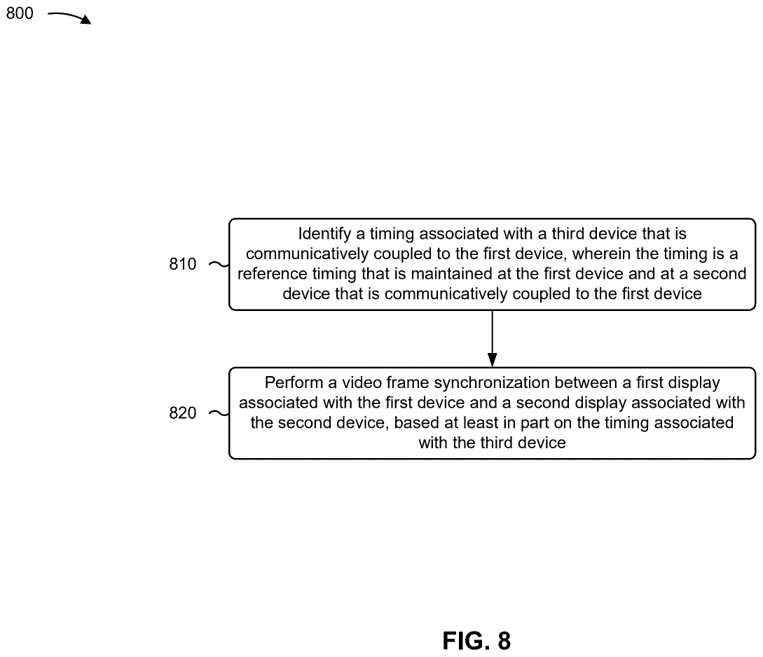

FIG. 8 is a flowchart of an example process 800 associated with video frame synchronization between displays associated with separate devices. In some implementations, one or more process blocks of FIG. 8 are performed by a first device (e.g., hub 238). In some implementations, one or more process blocks of FIG. 8 are performed by another device or a group of devices separate from or including the first device.

As shown in FIG. 8, process 800 may include identifying a timing associated with a third device that is communicatively coupled to the first device, wherein the timing is a reference timing that is maintained at the first device and at a second device that is communicatively coupled to the first device (block 810). For example, the first device may identify a timing associated with a third device that is communicatively coupled to the first device, wherein the timing is a reference timing that is maintained at the first device and at a second device that is communicatively coupled to the first device, as described above.

As further shown in FIG. 8, process 800 may include performing a video frame synchronization between a first display associated with the first device and a second display associated with the second device, based at least in part on the timing associated with the third device (block 820). For example, the first device may perform a video frame synchronization between a first display associated with the first device and a second display associated with the second device, based at least in part on the timing associated with the third device, as described above.

Process 800 may include additional implementations, such as any single implementation or any combination of implementations described below and/or in connection with one or more other processes described elsewhere herein.

In a first implementation, the video frame synchronization includes a synchronization between specific display events in relation to the first display and the second display, and the specific display events include a frame start event or a blank start event.

In a second implementation, alone or in combination with the first implementation, process 800 includes sending, to the second device, a frame synchronization indication of one or more of: the timing associated with the third device, or a presentation timestamp, wherein the video frame synchronization is based at least in part on the frame synchronization indication.

In a third implementation, alone or in combination with one or more of the first and second implementations, the frame synchronization indication is a non-USB4 indication, and the non-USB4 indication is sent between a first GPIO entity of a first device router associated with the first device and a second GPIO entity of a second device router associated with the second device.

In a fourth implementation, alone or in combination with one or more of the first through third implementations, the frame synchronization indication is a USB4 indication, and the USB4 indication is sent between a USB4 port associated with the first device and a USB4 port associated with the second device.

In a fifth implementation, alone or in combination with one or more of the first through fourth implementations, the frame synchronization indication is conveyed via a dedicated USB4 packet, or the frame synchronization indication is embedded as a field in an USB4 packet.

In a sixth implementation, alone or in combination with one or more of the first through fifth implementations, the video frame synchronization is between a first data stream and a second data stream, wherein the first data stream is to be displayed via the first display, and the second data stream is to be displayed via the second display.

In a seventh implementation, alone or in combination with one or more of the first through sixth implementations, the first device is a USB4 hub, the second device is a USB4 device, and the third device is a USB4 host.

In an eighth implementation, alone or in combination with one or more of the first through seventh implementations, the first device is a first USB4 hub, the second device is a second USB4 hub, and the third device is a USB4 host.

In a ninth implementation, alone or in combination with one or more of the first through eighth implementations, the video frame synchronization is based at least in part on a time synchronization associated with a USB4 standard.

In a tenth implementation, alone or in combination with one or more of the first through ninth implementations, the first device, the second device, and the third device are associated with a UE, and the UE is capable of supporting an extended reality functionality.

In an eleventh implementation, alone or in combination with one or more of the first through tenth implementations, the timing is an inter-domain timing that is maintained between separate devices associated with separate domains.

Although FIG. 8 shows example blocks of process 800, in some implementations, process 800 includes additional blocks, fewer blocks, different blocks, or differently arranged blocks than those depicted in FIG. 8. Additionally, or alternatively, two or more of the blocks of process 800 may be performed in parallel.

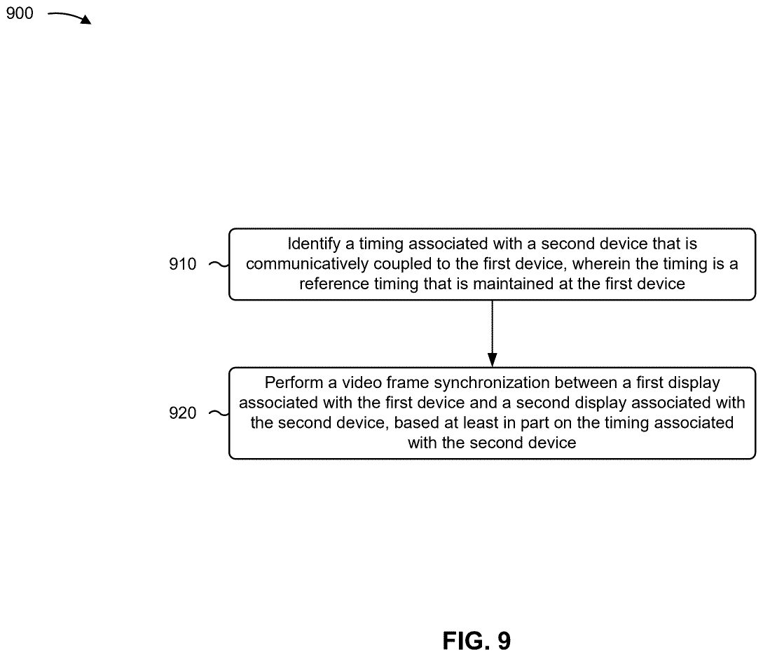

FIG. 9 is a flowchart of an example process 900 associated with video frame synchronization between displays associated with separate devices. In some implementations, one or more process blocks of FIG. 9 are performed by a first device (e.g., hub 236 or device 276). In some implementations, one or more process blocks of FIG. 9 are performed by another device or a group of devices separate from or including the first device.

As shown in FIG. 9, process 900 may include identifying a timing associated with a second device that is communicatively coupled to the first device, wherein the timing is a reference timing that is maintained at the first device (block 910). For example, the first device may identify a timing associated with a second device that is communicatively coupled to the first device, wherein the timing is a reference timing that is maintained at the first device, as described above.

As further shown in FIG. 9, process 900 may include performing a video frame synchronization between a first display associated with the first device and a second display associated with the second device, based at least in part on the timing associated with the second device (block 920). For example, the first device may perform a video frame synchronization between a first display associated with the first device and a second display associated with the second device, based at least in part on the timing associated with the second device, as described above.

Process 900 may include additional implementations, such as any single implementation or any combination of implementations described below and/or in connection with one or more other processes described elsewhere herein.

In a first implementation, the first device is a USB4 hub and the second device is a USB4 host.

In a second implementation, alone or in combination with the first implementation, the first device is a USB4 device and the second device is a USB4 host.

Although FIG. 9 shows example blocks of process 900, in some implementations, process 900 includes additional blocks, fewer blocks, different blocks, or differently arranged blocks than those depicted in FIG. 9. Additionally, or alternatively, two or more of the blocks of process 900 may be performed in parallel.

The following provides an overview of some Aspects of the present disclosure.

Aspect 1: A first device, comprising: one or more components configured to: identify a timing associated with a third device that is communicatively coupled to the first device, wherein the timing is a reference timing that is maintained at the first device and at a second device that is communicatively coupled to the first device; and perform a video frame synchronization between a first display associated with the first device and a second display associated with the second device, based at least in part on the timing associated with the third device.

Aspect 2: The first device of Aspect 1, wherein the video frame synchronization includes a synchronization between specific display events in relation to the first display and the second display, and wherein the specific display events include a frame start event or a blank start event.

Aspect 3: The first device of any of Aspects 1-2, wherein the one or more components, to perform the video frame synchronization, are configured to: send, to the second device, a frame synchronization indication of one or more of: the timing associated with the third device, or a presentation timestamp, wherein the video frame synchronization is based at least in part on the frame synchronization indication.

Aspect 4: The first device of Aspect 3, wherein the frame synchronization indication is a non-universal serial bus 4 (non-USB4) indication, and wherein the non-USB4 indication is sent between a first general-purpose input/output (GPIO) entity of a first device router associated with the first device and a second GPIO entity of a second device router associated with the second device.

Aspect 5: The first device of Aspect 3, wherein the frame synchronization indication is a universal serial bus 4 (USB4) indication, and wherein the USB4 indication is sent between a USB4 port associated with the first device and a USB4 port associated with the second device.

Aspect 6: The first device of Aspect 5, wherein the frame synchronization indication is conveyed via a dedicated USB4 packet, or wherein the frame synchronization indication is embedded as a field in an USB4 packet.

Aspect 7: The first device of any of Aspects 1-6, wherein the video frame synchronization is between a first data stream and a second data stream, wherein the first data stream is to be displayed via the first display, and wherein the second data stream is to be displayed via the second display.

Aspect 8: The first device of any of Aspects 1-7, wherein the first device is a universal serial bus 4 (USB4) hub, the second device is a USB4 device, and the third device is a USB4 host.

Aspect 9: The first device of any of Aspects 1-8, wherein the first device is a first universal serial bus 4 (USB4) hub, the second device is a second USB4 hub, and the third device is a USB4 host.

Aspect 10: The first device of any of Aspects 1-9, wherein the video frame synchronization is based at least in part on a time synchronization associated with a universal serial bus 4 (USB4) standard.

Aspect 11: The first device of any of Aspects 1-10, wherein the first device, the second device, and the third device are associated with a user equipment (UE), and wherein the UE is capable of supporting an extended reality functionality.

Aspect 12: The first device of any of Aspects 1-11, wherein the timing is an inter-domain timing that is maintained between separate devices associated with separate domains.

Aspect 13: A method, comprising: identifying, at a first device, a timing associated with a third device that is communicatively coupled to the first device, wherein the timing is a reference timing that is maintained at the first device and at a second device that is communicatively coupled to the first device; and performing, at the first device, a video frame synchronization between a first display associated with the first device and a second display associated with the second device, based at least in part on the timing associated with the third device.

Aspect 14: The method of Aspect 13, wherein the video frame synchronization includes a synchronization between specific display events in relation to the first display and the second display, and wherein the specific display events include a frame start event or a blank start event.

Aspect 15: The method of any of Aspects 13-14, wherein performing the video frame synchronization comprises: sending, by the first device to the second device, a frame synchronization indication of one or more of: the timing associated with the third device, or a presentation timestamp, wherein the video frame synchronization is based at least in part on the frame synchronization indication.

Aspect 16: The method of Aspect 15, wherein the frame synchronization indication is a non-universal serial bus 4 (non-USB4) indication, and wherein the non-USB4 indication is sent between a first general-purpose input/output (GPIO) entity of a first device router associated with the first device and a second GPIO entity of a second device router associated with the second device.

Aspect 17: The method of Aspect 15, wherein the frame synchronization indication is a universal serial bus 4 (USB4) indication, and wherein the USB4 indication is sent between a USB4 port associated with the first device and a USB4 port associated with the second device.

Aspect 18: The method of Aspect 17, wherein the frame synchronization indication is conveyed via a dedicated USB4 packet, or wherein the frame synchronization indication is embedded as a field in an USB4 packet.

Aspect 19: The method of any of Aspects 13-18, wherein the video frame synchronization is between a first data stream and a second data stream, wherein the first data stream is to be displayed via the first display, and wherein the second data stream is to be displayed via the second display.

Aspect 20: The method of any of Aspects 13-19, wherein the first device is a universal serial bus 4 (USB4) hub, the second device is a USB4 device, and the third device is a USB4 host.

Aspect 21: The method of any of Aspects 13-20, wherein the first device is a first universal serial bus 4 (USB4) hub, the second device is a second USB4 hub, and the third device is a USB4 host.

Aspect 22: The method of any of Aspects 13-21, wherein the video frame synchronization is based at least in part on a time synchronization associated with a universal serial bus 4 (USB4) standard.

Aspect 23: The method of any of Aspects 13-22, wherein the first device, the second device, and the third device are associated with a user equipment (UE), and wherein the UE is capable of supporting an extended reality functionality.

Aspect 24: The method of any of Aspects 13-23, wherein the timing is an inter-domain timing that is maintained between separate devices associated with separate domains.

Aspect 25: A first device, comprising: one or more components configured to: identify a timing associated with a second device that is communicatively coupled to the first device, wherein the timing is a reference timing that is maintained at the first device; and perform a video frame synchronization between a first display associated with the first device and a second display associated with the second device, based at least in part on the timing associated with the second device.

Aspect 26: The first device of Aspect 25, wherein the first device is a universal serial bus 4 (USB4) hub and the second device is a USB4 host.

Aspect 27: The first device of any of Aspects 25-26, wherein the first device is a universal serial bus 4 (USB4) device and the second device is a USB4 host.

Aspect 28: A system configured to perform one or more operations recited in one or more of Aspects 1-27.

Aspect 29: An apparatus comprising means for performing one or more operations recited in one or more of Aspects 1-27.

Aspect 30: A non-transitory computer-readable medium storing a set of instructions, the set of instructions comprising one or more instructions that, when executed by a device, cause the device to perform one or more operations recited in one or more of Aspects 1-27.

Aspect 26: A computer program product comprising instructions or code for executing one or more operations recited in one or more of Aspects 1-22.

The foregoing disclosure provides illustration and description but is not intended to be exhaustive or to limit the implementations to the precise forms disclosed. Modifications and variations may be made in light of the above disclosure or may be acquired from practice of the implementations described herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of implementations described herein. Many of these features may be combined in ways not specifically recited in the claims and/or disclosed in the specification. For example, the disclosure includes each dependent claim in a claim set in combination with every other individual claim in that claim set and every combination of multiple claims in that claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

When “a component” or “one or more components” (or another element, such as “a controller” or “one or more controllers”) is described or claimed (within a single claim or across multiple claims) as performing multiple operations or being configured to perform multiple operations, this language is intended to broadly cover a variety of architectures and environments. For example, unless explicitly claimed otherwise (e.g., via the use of “first component” and “second component” or other language that differentiates components in the claims), this language is intended to cover a single component performing or being configured to perform all of the operations, a group of components collectively performing or being configured to perform all of the operations, a first component performing or being configured to perform a first operation and a second component performing or being configured to perform a second operation, or any combination of components performing or being configured to perform the operations. For example, when a claim has the form “one or more components configured to: perform X; perform Y; and perform Z,” that claim should be interpreted to mean “one or more components configured to perform X; one or more (possibly different) components configured to perform Y; and one or more (also possibly different) components configured to perform Z.”

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Where only one item is intended, the phrase “only one,” “single,” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. As used herein, the term “multiple” can be replaced with “a plurality of” and vice versa. Also, as used herein, the term “or” is intended to be inclusive when used in a series and may be used interchangeably with “and/or,” unless explicitly stated otherwise (e.g., if used in combination with “either” or “only one of”).

What is claimed is:

1. A first device, comprising:
one or more components configured to:
identify a timing associated with a third device that is communicatively coupled to the first device, wherein the timing is a reference timing that is maintained at the first device and at a second device that is communicatively coupled to the first device; and
perform a video frame synchronization between a first display associated with the first device and a second display associated with the second device, based at least in part on the timing associated with the third device.

2. The first device of claim 1, wherein the video frame synchronization includes a synchronization between specific display events in relation to the first display and the second display, and wherein the specific display events include a frame start event or a blank start event.

3. The first device of claim 1, wherein the one or more components, to perform the video frame synchronization, are configured to:
send, to the second device, a frame synchronization indication of one or more of: the timing associated with the third device, or a presentation timestamp, wherein the video frame synchronization is based at least in part on the frame synchronization indication.

4. The first device of claim 3, wherein the frame synchronization indication is a non-universal serial bus 4 (non-USB4) indication, and wherein the non-USB4 indication is sent between a first general-purpose input/output (GPIO) entity of a first device router associated with the first device and a second GPIO entity of a second device router associated with the second device.

5. The first device of claim 3, wherein the frame synchronization indication is a universal serial bus 4 (USB4) indication, and wherein the USB4 indication is sent between a USB4 port associated with the first device and a USB4 port associated with the second device.

6. The first device of claim 5, wherein the frame synchronization indication is conveyed via a dedicated USB4 packet, or wherein the frame synchronization indication is embedded as a field in an USB4 packet.

7. The first device of claim 1, wherein the video frame synchronization is between a first data stream and a second data stream, wherein the first data stream is to be displayed via the first display, and wherein the second data stream is to be displayed via the second display.

8. The first device of claim 1, wherein the first device is a universal serial bus 4 (USB4) hub, the second device is a USB4 device, and the third device is a USB4 host.

9. The first device of claim 1, wherein the first device is a first universal serial bus 4 (USB4) hub, the second device is a second USB4 hub, and the third device is a USB4 host.

10. The first device of claim 1, wherein the video frame synchronization is based at least in part on a time synchronization associated with a universal serial bus 4 (USB4) standard.

11. The first device of claim 1, wherein the first device, the second device, and the third device are associated with a user equipment (UE), and wherein the UE is capable of supporting an extended reality functionality.

12. The first device of claim 1, wherein the timing is an inter-domain timing that is maintained between separate devices associated with separate domains.

13. A method, comprising:
identifying, at a first device, a timing associated with a third device that is communicatively coupled to the first device, wherein the timing is a reference timing that is maintained at the first device and at a second device that is communicatively coupled to the first device; and
performing, at the first device, a video frame synchronization between a first display associated with the first device and a second display associated with the second device, based at least in part on the timing associated with the third device.

14. The method of claim 13, wherein performing the video frame synchronization comprises:
sending, by the first device to the second device, a frame synchronization indication of one or more of: the timing associated with the third device, or a presentation timestamp, wherein the video frame synchronization is based at least in part on the frame synchronization indication.

15. The method of claim 14, wherein:
the frame synchronization indication is a non-universal serial bus 4 (non-USB4) indication, and wherein the non-USB4 indication is sent between a first general-purpose input/output (GPIO) entity of a first device router associated with the first device and a second GPIO entity of a second device router associated with the second device; or
the frame synchronization indication is a universal serial bus 4 (USB4) indication, and wherein the USB4 indication is sent between a USB4 port associated with the first device and a USB4 port associated with the second device.

16. The method of claim 15, wherein the frame synchronization indication is conveyed via a dedicated USB4 packet, or wherein the frame synchronization indication is embedded as a field in an USB4 packet.

17. The method of claim 13, wherein:
the first device is a universal serial bus 4 (USB4) hub, the second device is a USB4 device, and the third device is a USB4 host; or
the first device is a first USB4 hub, the second device is a second USB4 hub, and the third device is the USB4 host, and
the video frame synchronization is based at least in part on a time synchronization associated with a USB4 standard,
the first device, the second device, and the third device are associated with a user equipment (UE), and
the UE is capable of supporting an extended reality functionality.

18. A first device, comprising:
one or more components configured to:
identify a timing associated with a second device that is communicatively coupled to the first device, wherein the timing is a reference timing that is maintained at the first device; and
perform a video frame synchronization between a first display associated with the first device and a second display associated with the second device, based at least in part on the timing associated with the second device.

19. The first device of claim 18, wherein the first device is a universal serial bus 4 (USB4) hub and the second device is a USB4 host.

20. The first device of claim 18, wherein the first device is a universal serial bus 4 (USB4) device and the second device is a USB4 host.
